(19) United States
(12) Patent Application Publication
(10) Pub. No.: US 2014/0279298 A1
(43) Pub. Date: Sep. 18, 2014

(54) AUTOMATED RELEASE OF TEMPORARILY RESTRICTED FUNDS AND TRANSFER TO UNRESTRICTED FUNDS FOR NONPROFIT ORGANIZATIONS

(71) Applicant: Faridoon S. Khosravi, Baltimore, MD (US)

(72) Inventor: Faridoon S. Khosravi, Baltimore, MD (US)

(21) Appl. No.: 13/798,246

(22) Filed: Mar. 13, 2013

(51) Int. Cl. G06Q 40/00

(52) U.S. Cl. CPC G06Q 40/10
USPC 705/30

(57) ABSTRACT

An accounting system or application for nonprofit organizations is configured to automatically move an appropriate amount of temporarily restricted funds to unrestricted funds as requirements for fund releases are met. The system or application determines expenses that have occurred for a nonprofit organization during a predetermined time period. The system or application also automatically reduces temporarily restricted funds by an amount of the expenses incurred during the predetermined time period, and automatically increases temporarily restricted funds by the amount of expenses incurred during the predetermined time period.

### FIELD

The present invention generally pertains to accounting, and more specifically, to an accounting system or application for nonprofit organizations configured to automatically move an appropriate amount of temporarily restricted funds to unrestricted funds as requirements for fund releases are met.

### BACKGROUND

Fund accounting for nonprofit entities requires separate tracking of temporarily restricted and unrestricted funds to comply with the requirements of Statement of Financial Accounting Standards No. 116 (“FAS 116”). However, conventional accounting software applications are generally designed for commercial and government contracting entities, completely lacking such functionality For instance, Deltek's Costpoint® software lacked the ability to keep track of the constant and fluent release of temporarily restricted funds into unrestricted funds on an ongoing basis via the standard financial configurations and designs. This is because these financial architectures were compatible with, and designed for, commercial and government contracting entities. As such, manual entries into other applications, such as spreadsheets, were necessary for a nonprofit organization to attempt fund accounting with a conventional application.

Some software applications exist that are purportedly directed to nonprofit entities. However, these applications do not keep track of the constant and fluid release of temporarily restricted funds into unrestricted funds on an ongoing basis. Stated differently, manual computation and manual data entry is still required to move temporarily restricted funds to unrestricted funds. Accordingly, an accounting system or application for nonprofit organizations that is configured to automatically move an appropriate amount of temporarily restricted funds to unrestricted funds as requirements for fund releases are met may be beneficial.

### SUMMARY

Certain embodiments of the present invention may be implemented and provide solutions to the problems and needs in the art that have not yet been fully solved by conventional nonprofit accounting systems. For example, certain embodiments of the present invention automatically move an appropriate amount of temporarily restricted funds into unrestricted funds as requirements for fund releases are met.

In one embodiment of the present invention, a computer program is embodied on a computer-readable storage medium. The computer program is configured to cause at least one processor to determine when donor pledges are received from at least one donor, and when a donor pledge is received, increase temporarily restricted funds for a nonprofit organization by an amount of the donor pledge. The computer program is also configured to cause the at least one processor to determine when a donor pledge is received, and when the pledge is received, increase a billed receivables account by an amount of the pledge. The computer program is further configured to cause the at least one processor to track expenses incurred by the nonprofit organization during a predetermined time period and after the predetermined time period elapses, and check whether conditions necessary for a release of funds from temporarily restricted funds to unrestricted funds have been met. Additionally, when the conditions for the release of the temporarily restricted funds have been met, the computer program is further configured to cause the at least one processor to decrease the temporarily restricted funds by an amount of the expenses, and increase unrestricted funds by the amount of the expenses.

In another embodiment of the present invention, a computer-implemented method includes monitoring, by a computing system, at least one account to determine whether an expense has occurred for a nonprofit organization. The computer-implemented method also includes determining, by a computing system, based on the monitoring, that an expense has occurred for the nonprofit organization. The computer-implemented method further includes checking, by the computing system, whether conditions necessary for a release of temporarily restricted funds have been met. Additionally, when the conditions for the release of the temporarily restricted funds have been met, the computer implemented method includes decreasing, by the computing system, the temporarily restricted funds by an amount of the expense, and increasing, by the computing system, unrestricted funds by the amount of the expense.

In yet another embodiment of the present invention, an apparatus includes physical memory including computer program instructions and at least one processor configured to execute the computer program instructions. The at least one processor is configured to determine expenses that have occurred for a nonprofit organization during a predetermined time period. When conditions for the release of temporarily restricted funds have been met, the at least one processor is also configured to automatically reduce the temporarily restricted funds by an amount of the expenses incurred during the predetermined time period, and automatically increase unrestricted funds by the amount of expenses incurred during the predetermined time period.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is a project diagram illustrating a project structure for maintaining temporarily restricted funds and their transfer upon release from restrictions, according to an embodiment of the present invention.

FIG. 2 is a project diagram illustrating the process for computing revenue for donor 2 of FIG. 1, according to an embodiment of the present invention.

FIG. 3 is a flowchart illustrating a fund accounting process, according to an embodiment of the present invention.

FIG. 4 is a flowchart illustrating a fund accounting process, according to an embodiment of the present invention.

FIG. 5 is a flowchart illustrating a fund accounting process, according to an embodiment of the present invention.

FIG. 6 is a flowchart illustrating a fund accounting process, according to an embodiment of the present invention.

FIG. 7 illustrates a computing system for performing fund accounting, according to an embodiment of the present invention.

### DETAILED DESCRIPTION OF THE EMBODIMENTS

Some embodiments of the present invention use features and automated processes to move the appropriate amount of temporarily restricted funds into unrestricted funds as the requirements for the fund releases are met. This can be achieved without manual entries or the use of auxiliary software and spreadsheets. Stated differently, the process of some embodiments is fully automated, unlike conventional systems. Some embodiments are able to provide financial data pertaining to temporarily restricted and unrestricted funds that is readily available at the end of each accounting period, and/or on a fluent and ongoing basis.

Since financial reports should be available on an ongoing basis, production of financial reports for each financial period was a challenge and required substantial level of manual effort for nonprofit organizations using conventional applications such as Costpoint® software. To keep track of fund transfers from temporarily restricted to unrestricted funds, nonprofit organizations using Costpoint® software would need to make manual entries and use auxiliary software such as Excel® spreadsheets to keep track of releases of funds from temporarily restricted to unrestricted funds. This process is tedious and less efficient than an automated process, and is further prone to errors.

Some embodiments of the present invention may employ an automated process to transfer funds from temporarily restricted funds to unrestricted funds without manual entries and computations when the conditions for the transfer are met. Such embodiments may recognize temporarily restricted funds based on donations. In some embodiments, the release of temporarily restricted funds to unrestricted funds in nonprofits takes place mostly when the nonprofit starts doing the work (and incurring expenses). Some embodiments recognize the spending associated with the expenses and move funds from temporarily restricted funds to unrestricted funds accordingly. Appropriate amounts of funds may be automatically transferred from temporarily restricted funds to unrestricted funds when the conditions for release are met, i.e., when work is performed and expenses are incurred.

In conventional accounting software, manual computation and manual entry is required to move the correct portion of the temporarily restricted funds to unrestricted funds when the requisite criteria are met. Certain embodiments automatically make the fund transfers without human intervention, which has the benefit of being faster and more efficient than the long and tedious process of manual calculation and entry, and has the further benefit of avoiding human error. Economically, such embodiments may reduce the number hours required and the complexity of the work performed for accounting in nonprofit organizations and speed up the monthly closing process.

To record and maintain temporarily restricted and unrestricted funds, it is generally beneficial to create various accounts to track the funds. In some embodiments, these accounts may be those listed below in Table 1.

TABLE 1
NONPROFIT FUND ACCOUNTS

| Account Description: | Account Function Code: |
|---|---|
| Temporarily Restricted Revenue | Award Fee |
| Contra Revenue | Revenue |
| Unrestricted Revenue | Revenue |
| Cash in Bank | Balance Sheet |
| Billed Receivables | Balance Sheet |
| Unbilled | Balance Sheet |
| Multi-Job Credit | Expense |
| Multi-Job Debit | Expense |

FIG. 1 is a project diagram 100 illustrating a project structure for maintaining temporarily restricted funds and their transfer upon release from restrictions, according to an embodiment of the present invention. In some embodiments, the project structure is a logical data structure that captures data pertaining to revenue and expenses. The structure of the project may be important to proper functionality of some embodiments in order to facilitate moving data through proper channels during various processes. The project structure also facilitates computation of both temporarily restricted and unrestricted revenue. Unique branches are created for each donor, and these branches further split into two separate branches for temporarily restricted and unrestricted projects.

The top level (level 1) of the project includes Project Level 1 110, which serves as a holder for all project donors contributing to the project (i.e., activity). Level 2 includes all of the project donors. Here, Donor 1 120 holds temporarily restricted and unrestricted branches for donor 1. Similarly, Donor 2 122 holds temporarily restricted and unrestricted branches for donor 2.

Level 3 includes temporarily restricted and unrestricted project revenue for each donor, namely, Donor 1 Unrestricted Project Revenue 130, Donor 2 Unrestricted Project Revenue 132, Donor 1 Temporarily Restricted Project Revenue 150, and Donor 2 Temporarily Restricted Project Revenue 152. Level 4 includes project costs, namely, Donor 1 Unrestricted Project Cost 140, Donor 2 Unrestricted Project Cost 142, Donor 1 Temporarily Restricted Project Cost 160, and Donor 2 Temporarily Restricted Project Cost 162. In FIG. 1, the restricted and unrestricted branches branch out at level 3, but in some embodiments, they may branch out at any level. However, the restricted and unrestricted revenue branches should be separate in any case. Multi-job allocations may be setup to move costs from the restricted project branches to the unrestricted project branches. In some embodiments, direct cost ceilings may be setup on all accounts except multi job debit and multi-job credit accounts. This is done so revenue is computed on multi job credit and debit accounts. Otherwise, duplicate revenue would be present. Transfer accounts are generally setup to receive the debit resulting from a multi-job debit in an unrestricted project and a credit to a temporarily restricted project.

In some embodiments, the entire amount of the donation upon pledge is entered as an award fee, even if the pledge is to be paid in multiple payments, whether in the same fiscal year or future years per FAS 116. Invoices may be created for all payments with the appropriate due dates according to the pledge. During the month, all expenses (i.e., costs) may be charged to the temporarily restricted branch of the project at the cost level of the project.

A multi-job computation may be run and the entry may be posted to transfer all charges from the temporarily restricted project to the unrestricted project. The running of this computation may be automated, and it may occur on a recurring basis and/or at the end of predetermined time periods, such as monthly. Alternatively, a cost transfer process may be setup and used to move expenses from the temporarily restricted project to the unrestricted project. A regular journal may also accomplish the transfer, but this would be manual and not automated. A journal is a manual journal entry that debits the unrestricted project and credits the temporarily restricted project to move the cost out of the temporarily restricted project.

FIG. 2 is a project diagram 200 illustrating the process for computing revenue for donor 2 of FIG. 1, according to an embodiment of the present invention. The system creates temporarily restricted revenue 210 based on an award fee entered into Donor 2 Temporarily Restricted Revenue 210. The system then creates negative revenue in the contra revenue account 220 for Donor 2 Temporarily Restricted Revenue 210 based on a negative balance in the cost transfer account. The multi-job puts a credit (i.e., negative cost) in the temporarily restricted project. When revenue is computed in some embodiments, the system creates a revenue reduction entry (i.e., a debit to the contra revenue account). The contra (negative) revenue, combined with original award fee revenue, reduces the overall temporarily restricted revenue. On the other hand, the same multi job puts a debit cost in the unrestricted branch for donor 2, which creates an increase in the unrestricted revenue in the unrestricted branch of the project for donor 2 of the same amount. As a result, the temporarily restricted revenue is reduced by the amount of the incurred cost and the unrestricted revenue is increased by the same amount. Computation and posting of revenue can be set to start automatically.

A cost transfer then occurs at 230 from Donor 2 Temporarily Restricted Project Cost 162 to Donor 2 Unrestricted Project Cost 142. Unrestricted revenue is then transferred at 240 from Donor 2 Unrestricted Project Cost 142 to Donor 2 Unrestricted Project Revenue 132. The net result of this process is a reduction in temporarily restricted revenue (i.e., temporarily restricted revenue minus contra revenue) and an increase in unrestricted revenue in the unrestricted branch of the project.

An alternative setup for this process in some embodiments is to create a dummy project to record all expenses and move those expenses either through multi-job computations, project transfers, or regular journal entries as discussed before to allocate the expenses to the unrestricted project based on other criteria, such as the percentage of the donor's share in expenses. Once this is done, the steps in the process may be similar to 220, 230, and 240 in FIG. 2.

It should be noted that the specific structure of the project tree in some embodiments is dependent on the specific organization's preferences. Some embodiments facilitate the transfer of funds from temporarily restricted revenue to unrestricted revenue using the function codes for the accounts. These function codes may refer to the award fee, revenue, multi job cost transfer functionality, ceilings, etc., and automated system processes such as multi-job processing, revenue computation, and billing may be used to eliminate manual entries for those transfers.

FIG. 3 is a flowchart 300 illustrating a fund accounting process, according to an embodiment of the present invention. In some embodiments, the process of FIG. 3 may be performed, for example, by computing system 700 of FIG. 7. The process begins with receiving a pledge from a donor at 310. This pledge may be entered as an award under modification (“MODs”). In some embodiments, this may be the name of the screen where the award fee is entered. The pledge revenue is added to temporarily restricted funds at 320 and an invoice for the pledge amount is created at 330.

At 340, a partial payment for the pledge is received from the donor. However, in some embodiments, the entire pledge amount may be received. Expenses for a given time period are incurred at 350. This time period, for example, may be monthly, quarterly, a custom-defined time period, or any other suitable time period, as would be readily appreciated by a person of ordinary skill in the art. Multi-job operations are performed at 360. Revenues for unrestricted and temporarily restricted accounts are then computed at 370 and the process ends.

An example of a fund accounting process according to an embodiment of the present invention is provided below. This example is similar to the process of FIG. 3. Table 2 provides accounts for this example.

TABLE 2
EXAMPLE ACCOUNTS

| Acct. Number: | Acct. Description: | Acct. Function Code: |
|---|---|---|
| 310-10 | Temporarily Restricted | Award Fee |
| | Revenue | |
| 310-00 | Contra Revenue | Revenue |
| 310-01 | Unrestricted Revenue | Revenue |
| 1000-01 | Cash in Bank | Balance Sheet |
| 1100-00 | Billed Receivables | Balance Sheet |
| 120-00 | Unbilled | Balance Sheet |
| 990-10 | Multi-Job Credit | Expense |
| 990-20 | Multi-Job Debit | Expense |

In this example, a pledge of $2,000,000 is received from a donor, and an award of $2,000,000 is entered under MODs. Next, the system computes revenue and creates revenue of $2,000,000 in a temporarily restricted project.

| Account | Project | Dr. Amount | Cr. Amount |
|---|---|---|---|
| 120-00 | DONOR2.TEPMRESTR.00 | $2,000,000 | |
| 310-10 | DONOR2.TEPMRESTR.00 | | $2,000,000 |

An invoice is created for the amount of the pledge in the same project.

| Account | Project | Dr. Amount | Cr. Amount |
|---|---|---|---|
| 1100-00 | DONOR2.TEPMRESTR.00 | $2,000,000 | |
| 120-00 | DONOR2.TEPMRESTR.00 | | $2,000,000 |

At some point after the pledge, a payment of $1,000,000 is received from the donor. As a result, the system makes a $1,000,000 debit to Cash in Bank 1000-01 and adds a $1,000,000 credit to Billed Receivables 1100-00. At the end of the month, $550,000 in expenses have been incurred in the temporarily restricted branch of the donor project. The following multi-job computations are performed.

| Account | Project | Dr. Amount | Cr. Amount |
|---|---|---|---|
| 990-20 | DONOR2.UNRESTR.00 | $550,000 | |
| 990-10 | DONOR2.TEPMRESTR.00 | | $550,000 |

The revenue is then computed. The credit amount in account 990-10 creates a contra revenue amount, reducing the overall revenue for the temporarily restricted project by the amount of expenses incurred.

| | | | |
|---|---|---|---|
| 310-00 | DONOR2.TEPMRESTR.00 | $550,000 | |
| 120-00 | DONOR2.TEPMRESTR.00 | | $550,000 |

The debit amount in 990-20 created a positive revenue amount in the unrestricted project by the amount of expenses incurred.

| | | | |
|---|---|---|---|
| 120-00 | DONOR2.UNRESTR.00 | $550,000 | |
| 310-01 | DONOR2.UNRESTR.00 | | $550,000 |

The account balance may be analyzed after processing all transactions in the time period as follows.

| Account | Activity | Amount |
|---|---|---|
| 1100-00 | Receivable balance of $1,000,000 | $1,000,000 |
| 1000-01 | Increase in bank by $1,000,000 for payment | $1,000,000 |
| | received | |
| 120-00 | Nets out to zero for overall project | $0 |
| 310-01 | Shows a balance of $550,000 in unrestricted | ($550,000) |
| | revenue as a result of expenses incurred | |
| 310-00 | Shows a balance of $550,000 in negative | $550,000 |
| | revenue for the temporarily restricted project | |
| 310-10 | Shows a balance of $2,000,000 in positive | $2,000,000 |
| | revenue for the temporarily restricted project | |
| *** | The net revenue for the temporarily restricted | $1,450,000 |
| | project will be $1,450,000 | |

During the revenue computation, the zero ceiling level on all other direct costs limits the computation of the revenue to only be based on the account balances for 990-10 and 990-20. At the end of the fiscal year when the books are closed, assuming no other donations/expenses, the net revenue for temporarily restricted revenue will be $1,450,000 and the net revenue for unrestricted revenue will be $550,000.

FIG. 4 is a flowchart 400 illustrating a fund accounting process, according to an embodiment of the present invention. In some embodiments, the process of FIG. 4 may be performed, for example, by computing system 700 of FIG. 7. The process begins with determining when donor pledges are received from one or more donors, and when a donor pledge is received, increasing temporarily restricted funds for a nonprofit organization by an amount of the donor pledge at 410. The process also includes determining when a payment on a donor pledge is received, and when the payment is received, increasing a bank account by an amount of the payment at 420. The process further includes tracking expenses incurred by the nonprofit organization during a predetermined time period at 430.

After the predetermined time period elapses, the process proceeds to checking whether expenses have been incurred in the temporarily restricted project at 440. When the expenses have been incurred at 450, the temporarily restricted funds are decreased by an amount of the expenses at 460, and unrestricted funds are increased by the amount of the expenses at 470.

FIG. 5 is a flowchart 500 illustrating a fund accounting process, according to an embodiment of the present invention. In some embodiments, the process of FIG. 5 may be performed, for example, by computing system 700 of FIG. 7. The process begins with monitoring one or more accounts to determine whether an expense has occurred for a nonprofit organization at 510. The process also includes determining based on the monitoring, that an expense has occurred for the nonprofit organization at 520. The temporarily restricted funds are then decreased by an amount of the expense at 530, and the unrestricted funds are increased by the amount of the expense at 540.

FIG. 6 is a flowchart 600 illustrating a fund accounting process, according to an embodiment of the present invention. In some embodiments, the process of FIG. 6 may be performed, for example, by computing system 700 of FIG. 7. The process begins with determining expenses that have occurred for a nonprofit organization during a predetermined time period at 610. The temporarily restricted funds are then automatically reduced by an amount of the expenses incurred during the predetermined time period at 620, and unrestricted funds are automatically increased by the amount of expenses incurred during the predetermined time period at 630.

FIG. 7 illustrates a computing system for performing fund accounting, according to an embodiment of the present invention. System 700 includes a bus 705 or other communication mechanism for communicating information, and processor(s) 710 coupled to bus 705 for processing information. Processor(s) 710 may be any type of general or specific purpose processor, including a central processing unit (“CPU”) or application specific integrated circuit (“ASIC”). Processor(s) 710 may also have multiple processing cores, and at least some of the cores may be configured for specific functions. System 700 further includes a memory 715 for storing information and instructions to be executed by processor(s) 710. Memory 715 can be comprised of any combination of random access memory (“RAM”), read only memory (“ROM”), flash memory, cache, static storage such as a magnetic or optical disk, or any other types of non-transitory computer-readable media or combinations thereof. Additionally, system 700 includes a communication device 720, such as a transceiver, to wirelessly provide access to a communications network.

Non-transitory computer-readable media may be any available media that can be accessed by processor(s) 710 and may include both volatile and non-volatile media, removable and non-removable media, and communication media. Communication media may include computer-readable instructions, data structures, program modules or other data in a modulated data signal such as a carrier wave or other transport mechanism and includes any information delivery media.

Processor(s) 710 are further coupled via bus 705 to a display 725, such as a Liquid Crystal Display (“LCD”), for displaying information to a user. A keyboard 730 and a cursor control device 735, such as a computer mouse, are further coupled to bus 705 to enable a user to interface with system 700. However, in certain embodiments such as those for mobile computing implementations, a physical keyboard and mouse may not be present, and the user may interact with the device solely through display 725 and/or a touchpad (not shown). Any type and combination of input devices may be used as a matter of design choice.

In one embodiment, memory 715 stores software modules that provide functionality when executed by processor(s) 710. The modules include an operating system 740 for system 700. The modules further include a fund accounting module 745 that is configured to perform fund accounting for nonprofit organizations. System 700 may include one or more additional functional modules 750 that include additional functionality.

One skilled in the art will appreciate that a “system” could be embodied as a personal computer, a server, a console, a personal digital assistant (“PDA”), a cell phone, a tablet computing device, or any other suitable computing device, or combination of devices. Presenting the above-described functions as being performed by a “system” is not intended to limit the scope of the present invention in any way, but is intended to provide one example of many embodiments of the present invention. Indeed, methods, systems and apparatuses disclosed herein may be implemented in localized and distributed forms consistent with computing technology, including cloud computing systems.

It should be noted that some of the system features described in this specification have been presented as modules, in order to more particularly emphasize their implementation independence. For example, a module may be implemented as a hardware circuit comprising custom very large scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, RAM, tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The method steps performed in FIGS. 3-6 may be performed by a computer program, encoding instructions for the nonlinear adaptive processor to perform at least the methods described in FIGS. 3-6, in accordance with embodiments of the present invention. The computer program may be embodied on a non-transitory computer-readable medium. The computer-readable medium may be, but is not limited to, a hard disk drive, a flash device, a random access memory, a tape, or any other such medium used to store data. The computer program may include encoded instructions for controlling the nonlinear adaptive processor to implement the methods described in FIGS. 3-6, which may also be stored on the computer-readable medium.

The computer program can be implemented in hardware, software, or a hybrid implementation. The computer program can be composed of modules that are in operative communication with one another, and which are designed to pass information or instructions to display. The computer program can be configured to operate on a general purpose computer, or an ASIC.

It will be readily understood that the components of various embodiments of the present invention, as generally described and illustrated in the figures herein, may be arranged and designed in a wide variety of different configurations. Thus, the detailed description of the embodiments of the systems, apparatuses, methods, and computer programs of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A computer program embodied on a computer-readable storage medium, the computer program configured to cause at least one processor to:
determine when donor pledges are received from at least one donor, and when a donor pledge is received, increase temporarily restricted funds for a nonprofit organization by an amount of the donor pledge;
determine when a donor pledge is received, and when the pledge is received, increase a billed receivables account by an amount of the pledge;
track expenses incurred by the nonprofit organization during a predetermined time period;
after the predetermined time period elapses, checking whether conditions necessary for a release of funds from temporarily restricted funds to unrestricted funds have been met; and
when the conditions for the release of the temporarily restricted funds have been met, decrease the temporarily restricted funds by an amount of the expenses, and increase unrestricted funds by the amount of the expenses.

2. The computer program of claim 1, wherein the conditions necessary for the release of the temporarily restricted funds comprise when work has been performed and expenses are incurred.

3. The computer program of claim 1, the program further configured to cause the at least one processor to:
create separate branches for temporarily restricted funds and unrestricted funds in a project for each donor, wherein
funds in the temporarily restricted branch are decreased and the funds in the unrestricted branch are increased when the conditions necessary for the release of funds are met.

4. The computer program of claim 3, wherein the program is further configured to cause the at least one processor to track project cost and project revenue separately for each of the branches.

5. The computer program of claim 3, wherein when the conditions necessary for the release of the funds are met, the program is further configured to cause the at least one processor to:
subtract contra revenue in an amount of the incurred expenses from temporarily restricted project revenue;
transfer cost in the amount of the expenses from temporarily restricted project cost to unrestricted project cost; and
transfer unrestricted revenue in the amount of the expenses from unrestricted project cost to unrestricted project revenue.

6. The computer program of claim 1, wherein the predetermined time period is monthly or quarterly.

7. A computer-implemented method, comprising:
monitoring, by a computing system, at least one account to determine whether an expense has occurred for a nonprofit organization;
determining, by a computing system, based on the monitoring, that an expense has occurred for the nonprofit organization;
checking, by the computing system, whether expenses have been incurred in a temporarily restricted project; and
when the expenses have been incurred, decreasing, by the computing system, the temporarily restricted funds by an amount of the expense, and increasing, by the computing system, unrestricted funds by the amount of the expense.

8. The computer-implemented method of claim 7, further comprising:
determining, by the computing system, when donor pledges are received from at least one donor; and
when a donor pledge is received, increasing, by the computing system a bank account for the nonprofit organization by an amount of the donor pledge.

9. The computer-implemented method of claim 7, further comprising:
creating, by the computing system, separate branches for temporarily restricted funds and unrestricted funds in a project for each donor, wherein
funds in the temporarily restricted branch are decreased and the funds in the unrestricted branch are increased when the conditions necessary for the release of funds are met.

10. The computer-implemented method of claim 9, wherein the project cost and project revenue are tracked separately for each of the branches.

11. The computer-implemented method of claim 7, wherein conditions necessary for the release of the temporarily restricted funds comprise when work has been performed and expenses are incurred.

12. The computer-implemented method of claim 11, wherein when the conditions necessary for the release of the funds are met, the method further comprises:
subtracting, by the computing system, contra revenue in an amount of the incurred expenses from temporarily restricted project revenue;
transferring, by the computing system, cost in the amount of the expenses from temporarily restricted project cost to unrestricted project cost; and
transferring, by the computing system, unrestricted revenue in the amount of the expenses from unrestricted project cost to unrestricted project revenue.

13. An apparatus, comprising:
physical memory comprising computer program instructions; and
at least one processor configured to execute the computer program instructions, the at least one processor configured to:
determine expenses that have occurred for a nonprofit organization during a predetermined time period, and
when conditions for the release of temporarily restricted funds have been met, automatically reduce the temporarily restricted funds by an amount of the expenses incurred during the predetermined time period, and automatically increase unrestricted funds by the amount of expenses incurred during the predetermined time period.

14. The apparatus of claim 13, wherein the at least one processor is further configured to:
determine when donor pledges are received from at least one donor, and
when a donor pledge is received, increase the temporarily restricted funds for the nonprofit organization by an amount of the donor pledge.

15. The apparatus of claim 13, wherein the conditions necessary for the release of the temporarily restricted funds comprise when work has been performed and expenses are incurred.

16. The apparatus method of claim 13, wherein the at least one processor is further configured to:
create separate branches for temporarily restricted funds and unrestricted funds in a project for each donor, wherein
funds in the temporarily restricted branch are decreased and the funds in the unrestricted branch are increased when the conditions necessary for the release of funds are met.

17. The apparatus of claim 16, wherein the at least one processor is further configured to track project cost and project revenue separately for each of the branches.

18. The apparatus of claim 16, wherein when the conditions necessary for the release of the funds are met, the at least one processor is further configured to:
subtract contra revenue in an amount of the incurred expenses from temporarily restricted project revenue,
transfer cost in the amount of the expenses from temporarily restricted project cost to unrestricted project cost, and
transfer unrestricted revenue in the amount of the expenses from unrestricted project cost to unrestricted project revenue.

19. The apparatus of claim 13, wherein the predetermined time period is monthly or quarterly.

20. The apparatus of claim 13, wherein the at least one processor is further configured to determine when a payment on a donor pledge is received, and when the payment is received, increase a bank account by an amount of the payment.
